(19) United States
(12) Patent Application Publication
(10) Pub. No.: US 2003/0133713 A1
(43) Pub. Date: Jul. 17, 2003

(54) Method and system for multi-level power management in an optical network

(76) Inventors: Eddie Kai Ho Ng, Ottawa (CA); Derrick Remedios, Ottawa (CA); Ping Wai Wan, Ottawa (CA); Robert Michael Bierman, Ottawa (CA); Dung Van Nguyen, Ottawa (CA)

Correspondence Address: TROPIC NETWORKS INC., DR. VICTORIA DONNELLY, 135 MICHAEL COWPLAND DRIVE, KANATA, ON, K2M 2E9, CA

(21) Appl. No.: 10/260,619

(22) Filed: Oct. 1, 2002

Related U.S. Application Data
(60) Provisional application No. 60/348,612, filed on Jan. 17, 2002.
(60) Provisional application No. 60/354,025, filed on Feb. 5, 2002.
(60) Provisional application No. 60/365,791, filed on Mar. 21, 2002.
(60) Provisional application No. 60/365,779, filed on Mar. 21, 2002.

(51) Int. Cl. H04B 10/02

(52) U.S. Cl. 398/37; 398/38

(57) ABSTRACT

A method and system for multi-level power management in an optical network is provided. They include three levels of control of an amplifier. The first level of control maintains the gain of the amplifier operating in automatic gain control (AGC) mode at a target amplifier gain. The second level of control eliminates channel gain excursion by dynamically changing the amplifier target gain so as to provide that the gain for each channel is within a gain ripple of the amplifier. The third level of control sets the target gains of amplifiers according to fiber span losses. The third level of control also performs pre-emphasis of channel powers by changing the power of one or more channels passing through the amplifier so as to compensate for gain ripple of the amplifier. As a result, this multi-level control of the amplifiers in the network provides an increased level of optical signal to noise ratio (OSNR), protection of network components, and stabilization of channel power in the network. Each level of control facilitates a different aspect of power management, thus complimenting each other to provide enhanced power management.

### RELATED APPLICATIONS

This application claims benefit of U.S. Provisional Patent Application to Ng et al, Serial No. 60/348,612 filed on Jan. 17, 2002; and of U.S. Provisional Patent Application to Ng et al, Serial No. 60/354,025 filed on Feb. 5, 2002; and of U.S. Provisional Application to Ng et al, Serial No. 60/365,791 filed on Mar. 21, 2002; and of U.S. Provisional Patent Application to Wan et al, Serial No. 60/365,779 filed on Mar. 21, 2002; and of U.S. Patent Application to Ng et al, Ser. No. 10/195,495 filed on Jul. 16, 2002 entitled “Method and Apparatus for Gain Excursion Minimization in Automatic Gain Controlled Optical Systems”; and is related to a U.S. patent application to Wan et al, entitled “Method and System for Automatic Initialization of an Optical Network”, filed concurrently herewith.

### FIELD OF THE INVENTION

The present invention relates to optical networks, and in particular, to a method and system for multi-level power management in an optical network.

### BACKGROUND OF THE INVENTION

The objectives of power management in optical networks depend on many factors, including the distance covered by a network and the transmission speed of the network. Long-haul networks have generally been designed to maximize and maintain transmission power of optical channels at the required level over long distances and fairly stable configurations of the network. However, the focus of smaller, for example metropolitan area networks (MANs), is shifting towards supporting the dynamic adding and dropping of channels due to network upgrades and reconfigurations, which cause frequent variation in optical power levels and therefore requires dynamic and comprehensive power management in an optical network.

Several different approaches to power management in an optical network are currently available. Power management of optical components, such as optical amplifiers, using an electronic variable optical attenuator (eVOA) and a controller provides local control of the component. Unfortunately, the local control of the component does not take into account larger-scale information regarding network configuration and conditions, and hence has inherent drawbacks.

Another known approach to power management is the use of dynamic gain equalizers (DGEs) to reduce variations of channel optical power in the network. However, for short distances, such as in metropolitan/regional networks, the use of DGEs is not an economically attractive option.

In the U.S. Pat. No. 6,304,347 to Beine et al. issued Oct. 16, 2001 and entitled “Optical Power Management in an Optical Network”, a bi-directional line-switched ring optical network is disclosed, which is configured in such a way that in the event of network switching, equal or nearly equal power levels per wavelength are maintained between neighboring network elements. Additionally, provision has been made to provide network protection from path failure. This patent provides certain control of amplifier(s) and other related network element(s) by maintaining uniform power levels between working and protection paths. However, it provides power management of the network which is specific to switching events in the network and therefore is inherently limited.

Therefore, there is a need in industry for the development of an improved method for effective, comprehensive, and accurate power management in an optical network.

### SUMMARY OF THE INVENTION

Therefore there is an object of the invention to provide a method and system for multi-level power management in an optical network that would avoid or minimize the above-mentioned drawbacks.

According to one aspect of the invention, there is provided a method for automatic multi-level power management in an optical network, comprising the steps of:

(a) providing a multi-level control of the amplifier, including:

(i) automatically determining a span loss of each fiber span in the network;

(ii) setting a target gain of the amplifier to be equal to a span loss of the fiber span immediately following the amplifier;

(iii) regulating the amplifier gain so as to be equal to said target gain;

(iv) dynamically changing said target gain of the amplifier so as to provide that a gain of a channel passing through the amplifier is within a predetermined gain range; and

(b) changing power of one or more channels passing through the amplifier so as to provide that power variation for the channels passing through the amplifier is within a predetermined power range.

The step (a) of automatically determining the span loss may comprise:

(c) selecting a channel on the optical link and turning on the channel power at the corresponding transmitter;

(d) increasing the power at said transmitter until the signal power level at the amplifier nearest to said transmitter reaches a predetermined power level;

(e) varying a target gain of said amplifier until the signal power level at the network element nearest to the amplifier reaches said predetermined power level;

(f) repeating the step (e) until the signal power level at all network elements on the optical link reaches the same said predetermined power level;

(g) determining the span loss of each fiber span as being equal to the following value:

the difference between the power at the transmitter in the step (d) and said predetermined power level, if the fiber span is located between said transmitter and the optical amplifier nearest to the transmitter; and

the target gain of the amplifier immediately preceding the fiber span, the target gain being set in the step (e), if the fiber span is any of the remaining spans of fiber.

Alternatively, the step (a) of automatically determining the span loss may comprise:

determining a signal power level at an input of a fiber span in the optical link;

determining a signal power level at an output of the fiber span in the optical link; and

determining the loss for the fiber span to be equal to the difference between said signal power level at the input of the fiber span and said signal power level at the output of the fiber span.

Additionally, the step (iv) of dynamically changing the target gain of the amplifier may comprise changing the target gain of the amplifier so as to provide that the gain of a channel passing through the amplifier is within the predetermined gain range defined as the gain ripple of the amplifier, the gain ripple being a variation of the amplifier gain profile with channel wavelength.

Furthermore, the step (b) of changing the power may further comprise changing the power of one or more channels passing through the amplifier so as to provide that the power variation for the channels passing through the amplifier is opposite to the cumulative gain ripple of the amplifiers in the link so as to compensate for the cumulative gain ripple, the cumulative gain ripple of the amplifiers being a variation of the amplifiers cumulative gain profile with channel wavelength.

In a modification to the embodiment of the invention, the method for automatic multi-level power management in an optical network, comprises the steps of providing a multi-level control of the amplifier, including:

(i) automatically determining span losses;

(ii) setting a target gain of the amplifier to be equal to a span loss of the fiber span immediately following the amplifier;

(iii) regulating the amplifier gain so as to be equal to said target gain; and

(iv) dynamically changing said target gain of the amplifier so as to ensure that a gain of a channel passing through the amplifier is within a predetermined gain range.

The step (iv) of dynamically changing the target gain of the amplifier may comprise changing the target gain of the amplifier so as to provide that the gain of a channel passing through the amplifier is within the predetermined gain range defined as the gain ripple of the amplifier, the gain ripple being a variation of the amplifier gain profile with channel wavelength.

In another modification to the embodiment of the invention, the method for automatic multi-level power management in an optical network comprises the steps of:

(a) providing a multi-level control of the amplifier, including:

(i) automatically determining span losses;

(ii) setting a target gain of the amplifier to be equal to a span loss of the fiber span immediately following the amplifier;

(iii) regulating the amplifier gain so as to be equal to said target gain; and

(b) changing power of one or more channels passing through the amplifier so as to provide that power variation for the channels passing through the amplifier is within a predetermined power range.

The step (b) of changing the power may further comprise changing the power of one or more channels passing through the amplifier so as to provide that the power variation for the channels passing through the amplifier is opposite to the cumulative gain ripple of the amplifiers in the link so as to compensate for the cumulative gain ripple, the cumulative gain ripple of the amplifiers being a variation of the amplifiers cumulative gain profile with channel wavelength.

According to another aspect of the invention, a system for automatic multi-level power management in an optical network comprises:

(a) means for providing a multi-level control of the amplifier, including:

(i) means for automatically determining span losses;

(ii) means for setting a target gain of the amplifier to be equal to a span loss of the fiber span immediately following the amplifier;

(iii) means for regulating the amplifier gain so as to be equal to said target gain;

(iv) means for dynamically changing said target gain of the amplifier so as to ensure that gain of a channel passing through the amplifier is within a predetermined gain range; and

(b) means for changing power of one or more channels passing through the amplifier so as to provide that power variation for the channels passing through the amplifier is within a predetermined power range.

The means (iv) for dynamically changing the target gain of the amplifier may comprise means for changing the target gain of the amplifier so as to provide that the gain of a channel passing through the amplifier is within the predetermined gain range defined as the gain ripple of the amplifier, the gain ripple being a variation of the amplifier gain profile with channel wavelength.

Additionally, the means (b) for changing the power may further comprise means for changing the power of one or more channels passing through the amplifier so as to provide that the power variation for the channels passing through the amplifier is opposite to the cumulative gain ripple of the amplifiers in the link so as to compensate for the cumulative gain ripple, the cumulative gain ripple of the amplifiers being a variation of the amplifiers cumulative gain profile with channel wavelength.

In a modification to the embodiment of the invention, the system for automatic multi-level power management in an optical network comprises means for providing a multi-level control of the amplifier, including:

(i) means for automatically determining span losses;

(ii) means for setting a target gain of the amplifier to be equal to a span loss of the fiber span immediately following the amplifier;

(iii) means for regulating the amplifier gain so as to be equal to said target gain; and

(iv) means for dynamically changing said target gain of the amplifier so as to ensure that gain of a channel passing through the amplifier is within a predetermined gain range.

The means (iv) for dynamically changing the target gain of the amplifier may comprise means for changing the target gain of the amplifier so as to provide that the gain of a channel passing through the amplifier is within the predetermined gain range defined as the gain ripple of the amplifier, the gain ripple being a variation of the amplifier gain profile with channel wavelength.

In another modification to the embodiment of the invention, the system for automatic multi-level power management in an optical network comprises:

(a) means for providing a multi-level control of the amplifier, including:

(i) means for automatically determining span losses;

(ii) means for setting a target gain of the amplifier to be equal to a span loss of the fiber span immediately following the amplifier;

(iii) means for regulating the amplifier gain so as to be equal to said target gain; and

(b) means for changing power of one or more channels passing through the amplifier so as to provide that power variation for the channels passing through the amplifier is within a predetermined power range.

The means (b) for changing the power may further comprise means for changing the power of one or more channels passing through the amplifier so as to provide that the power variation for the channels passing through the amplifier is opposite to the cumulative gain ripple of the amplifiers in the link so as to compensate for the cumulative gain ripple, the cumulative gain ripple of the amplifiers being a variation of the amplifiers cumulative gain profile with channel wavelength.

The method and system for multi-level power management in an optical network of the embodiments of the invention provide the following advantages. By adjusting the target gain of each amplifier to be equal to span losses of fiber spans instead of the typical procedure of reducing signal power to match the span losses, Optical Signal-to-Noise Ratio (OSNR) in the network is improved. Component protection is another advantage provided by the embodiments of the invention. By setting the target gains of amplifiers to be equal to the span losses of fiber spans, component protection is ensured. Finally, the layered structure of the power management in the network as described above allows modular implementation of different functionalities of the power management.

### BRIEF DESCRIPTION OF THE DRAWINGS

Embodiments of the invention will now be described, by way of example, with reference to the accompanying drawings in which:

FIG. 1 illustrates a system for multi-level power management in an optical network according to the embodiment of the invention;

FIG. 2 illustrates a sub-system providing a first level control of an optical amplifier in the system of FIG. 1;

FIG. 3 illustrates a sub-system providing a second level control of an optical amplifier in the system of FIG. 1;

FIG. 4 illustrates a sub-system providing a third level control of an optical amplifier, determination of span losses and pre-emphasis of channels in the system of FIG. 1; and

FIG. 5 is a diagram illustrating the steps of the method for multi-level power management in the optical network performed in the system of FIG. 1.

### DETAILED DESCRIPTION OF THE PREFERRED EMBODIMENTS

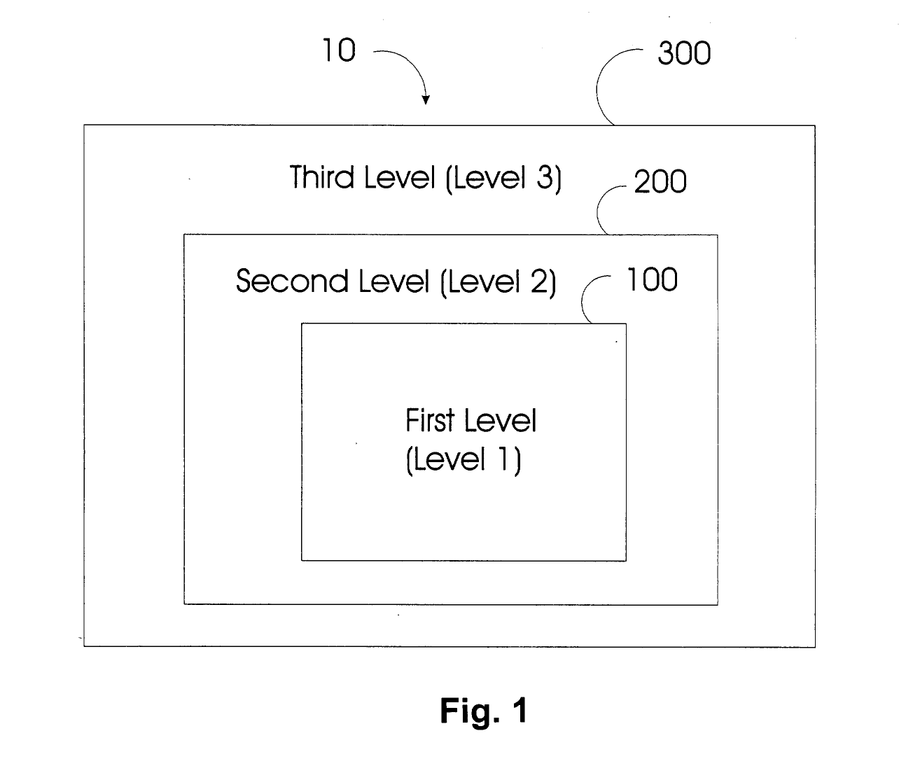

A system 10 for multi-level power management in an optical network, according to the embodiment of the invention, is illustrated with the aid of FIGS. 1 to 5. The system 10 comprises three sub-systems: the sub-system 100 of the first level (level 1), the sub-system 200 of the second level (level 2), and the sub-system 300 of the third level (level 3), as shown in FIG. 1.

The sub-systems of the first, second, and third levels (100, 200, and 300 respectively) provide control of an amplifier locally, at a card level, and at a link level respectively. Additionally, the subsystem 300 also automatically determines span losses of fiber spans in the network and performs pre-emphasis on the channels in the network. Thus, each sub-system performs a different aspect of power management in the network, the details of which will be described below.

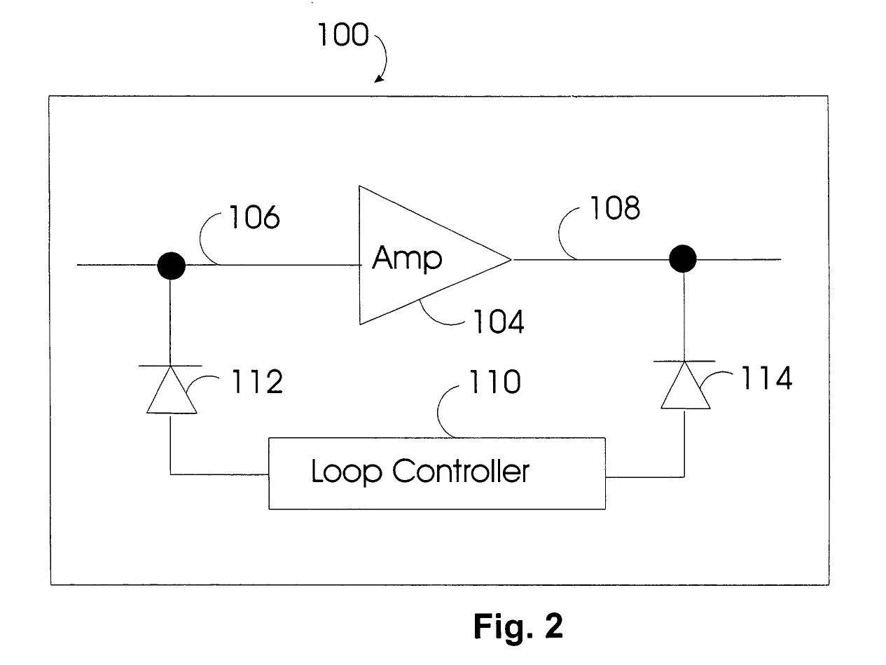

FIG. 2 illustrates the sub-system 100 providing the first level control of the optical amplifier. It includes a commercially available amplifier 104, having an input 106 and output 108 and an automatic gain control (AGC) loop. The AGC loop includes a loop controller 110, and input and output channel power monitors 112 and 114 at the input 106 and the output 108 of the amplifier respectively. The input and output monitors 112 and 114 may be detectors such as PIN photodiodes. Also, the optical amplifier 104 may be a double pumped EDFA or an amplifier with other types of rare earth doped fibers.

The sub-system 100 providing the first level control of the optical amplifier 104 operates as follows. The loop controller 110 dynamically regulates the amplifier gain so as to be equal to a target gain of the amplifier by regulating the amplifier pump current. The optical amplifier 104 thus operates in AGC mode.

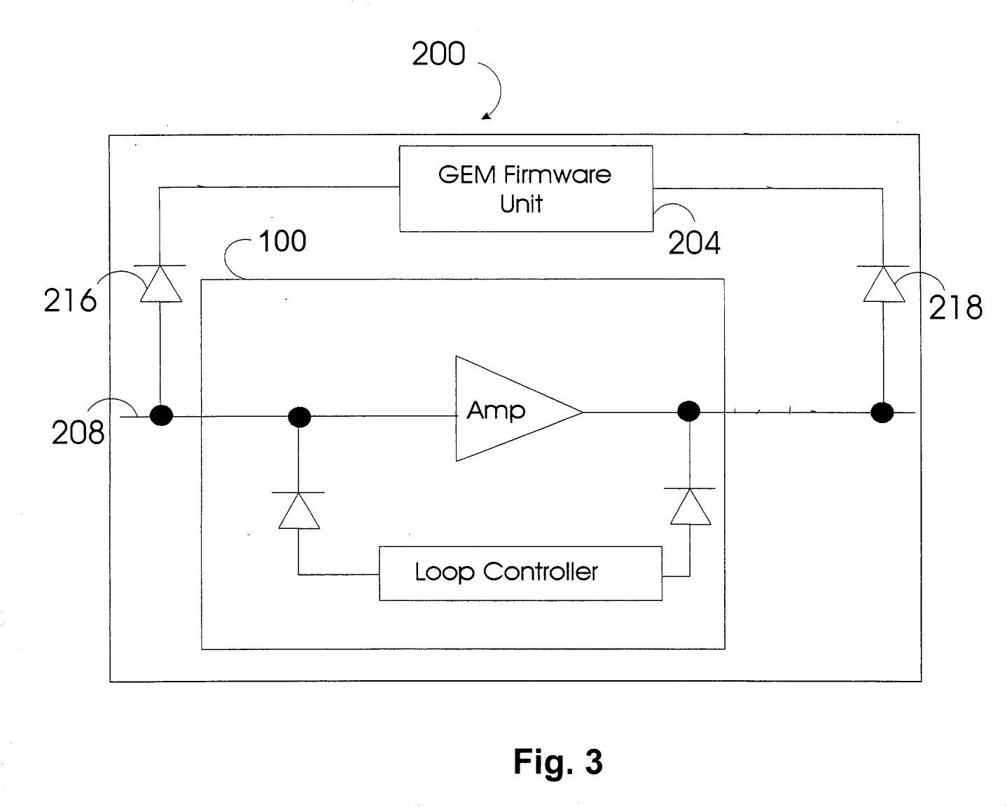

FIG. 3 illustrates the sub-system 200 providing the second level control of the optical amplifier 104. It includes the sub-system 100 operating in AGC mode, the subsystem 100 having an input 208 and output 210 connected via a gain excursion minimization (GEM) loop. The GEM loop includes a GEM firmware unit 204, and input and output channel power monitors 216 and 218 at the input 208 and the output 210 of the amplifier subsystem 100 respectively.

The sub-system 200 providing the second level control of the optical amplifier operates as follows. The GEM firmware unit 204 dynamically changes the target gain of the amplifier so as to minimize or eliminate channel gain excursion, as will be elaborated below.

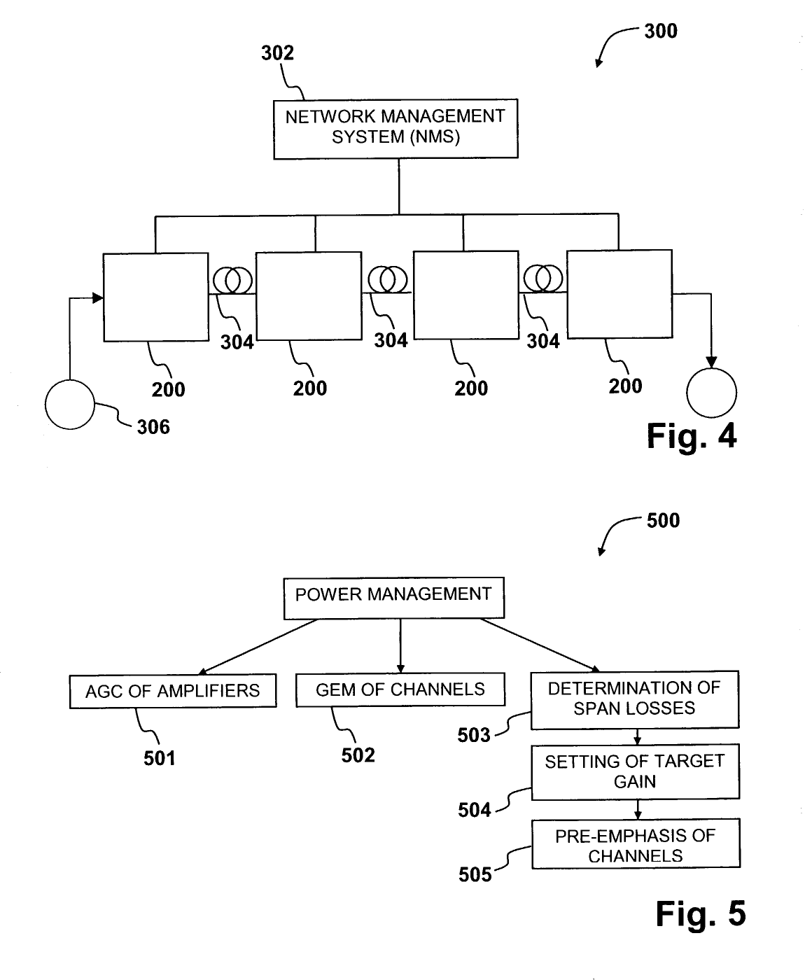

FIG. 4 illustrates the sub-system 300 providing the third level control of the optical amplifier, automatic determination of span losses, and pre-emphasis of channels. It includes a number of second level sub-systems 200, linked together by spans of fiber 304 and managed by a network management system (NMS) 302.

The sub-system 300 providing the third level control of the optical amplifier operates as follows. The NMS 302 automatically determines span losses of fiber spans in the network and then sets the target gain of the amplifier to be equal to the span loss of the fiber span immediately following the amplifier. The NMS 302 also performs pre-emphasis on the channels in the optical network in such a manner that channel powers at the transmitters 306 are biased to compensate for the effects of optical amplifier gain ripple.

Thus, a system for multi-level power management in an optical network is provided including three subsystems 100, 200, and 300 for local, card level, and link level control respectively of an amplifier in the network, as well as automatic determination of span losses and pre-emphasis of channels in the network.

FIG. 5 is a diagram 500 illustrating the steps of the method for multi-level power management in the optical network performed in the system of FIG. 1. On the third level of the power management, the steps 503 to 505 of the method for multi-level power management are the automatic determination of span loss (box 503), the setting of target gain based on span loss (box 504), and the application of pre-emphasis over the channels in the network (box 505), an optical link being a path of a signal from a transmitter to a receiver.

The span loss is automatically determined according to the methods described in detail in U.S. Provisional Application Serial No. 60/365,779 to Wan et al. filed Mar. 21, 2002 and entitled “Fiber Wide Initialization Optical System Set-Up Procedure” and in regular U.S. Patent Application to Wan et al. entitled “Method for Automatic Initialization of an Optical Network” filed concurrently herewith.

In one embodiment, the step of automatically determining span loss comprises varying transmitter powers and amplifier gains until a predetermined power level is present at all network elements. The span loss L₀ of the fiber span located between the transmitter 306 and the optical amplifier nearest to the transmitter is the difference between the power at the transmitter, as measured by a channel power monitor at the transmitter, and the predetermined power level mentioned above. The span loss of any of the remaining fiber spans in the link is equal to the target gain of the amplifier 104 immediately preceding the fiber span 304.

In a modification to the above embodiment, the step of automatically determining span loss comprises determining the input and output signal power level of each optical amplifier 104 using the channel power monitors 208 and 218 and calculating the difference between the signal power level at the output of each fiber span (i.e. input to an amplifier) and the signal power level at the input of each fiber span (i.e. output of preceding amplifier). This difference in input and output signal power levels is the span loss of the fiber span.

As mentioned above, the target gain of each amplifier is then set to be equal to the span loss of the fiber span immediately following the amplifier.

The application of pre-emphasis on the channels in the network involves biasing channel powers at the transmitters to compensate or substantially compensate for the effects of optical amplifier gain ripple, which is a variation of the amplifier gain profile with channel wavelength. This is accomplished by changing the power of one or more channels passing through the amplifier so as to provide that the power variation for the channels passing through the amplifier is minimized or is within a predetermined power range.

On the second level of the power management, the step 502 of the method for multi-level power management performs minimization of gain excursion for individual channels for each amplifier in the network. Gain excursion is defined as a deviation of the gain of a channel passing through the amplifier beyond specified gain ripple of the amplifier, the deviation being caused by uneven distribution of channels passing through the amplifier. Gain excursion minimization (GEM) involves the measurement of the input and output channel powers from the input and output channel power monitors 216 and 218 to determine channel gains as the ratio of the output to input channel powers. The target gain is then calculated by the GEM firmware unit 204 according to the methods described in detail in U.S. Provisional Applications Serial Nos. 60/348,612 and 60/354,025 to Ng et al. and in regular U.S. patent application Ser. No. 10/195,495 to Ng et al. filed Jul. 16, 2002 and entitled “Method and Apparatus for Gain Excursion Minimization in Automatic Gain Controlled Optical Systems” so as to provide that a gain of a channel passing through the amplifier is within a predetermined gain range.

On the first level of local control of the power management, the step 501 of the method for multi-level power management is the AGC of the optical amplifiers 104. Variations in amplifier gain are compensated by adjusting pump laser power to maintain a constant average gain through all channels that carry a signal.

The described system and method for multi-level power management in an optical network have the following advantages. By adjusting the target gain of each amplifier to be equal to span losses of fiber spans instead of the typical procedure of reducing signal power to meet a pre-determined input power level at the amplifier, OSNR in the network is improved. The physical reason behind this is as follows. Amplified Stimulated Emission (ASE) noise degrades the OSNR of an optical signal every time the signal passes through an optical amplifier, and the magnitude of the OSNR degradation depends primarily on the input power to the amplifier.

Component protection is another advantage provided by the embodiment of the invention. By setting the target gains of amplifiers to be equal to the span losses of fiber spans, component protection is ensured. It may be especially important when span losses in the deployed network are higher than specified losses from the network planning stage, given rise to risks of component damage or amplifier saturation.

Additionally, the layered structure of the power management in the network as described above allows modular implementation of different functionalities of the power management. For example, improvement of OSNR is facilitated by the third level step 504 of setting the target gain based on span loss while dynamic network provisioning is facilitated by the second level step 502 of minimization of gain excursion for individual channels for each amplifier in the network.

Thus, the embodiment of the present invention provides a system and method for multi-level optical power management including AGC of amplifiers, gain excursion minimization, and pre-emphasis of channels in the optical network. The embodiment of the invention also provides a system for power management in the network that is modular, prevents component damage due to excessive power, and improves OSNR.

In a modification to the method of the embodiment of the invention, the power management of the optical network may include only the first (local) and second (card level) of control.

In another modification to the method of the embodiment of the invention, the power management of the optical network may include only a first (local) and a third (link level) of control of an amplifier as well as automatic determination of span losses and pre-emphasis of channels in the network.

In yet another modification to the method of the embodiment of the invention, the power management of the optical network may include more than three levels of control. Additional levels may be, for example, a fourth level of control, in which NMSs 302 of different networks interact to provide control of amplifiers in different networks.

It is apparent to those skilled in the art that there are many variations of the present invention that retain the spirit of the invention. Thus it is intended that the present invention covers the modifications, variations, and adaptations of this invention provided they fall within the scope of the following claims.

What is claimed is:

1. A method for automatic multi-level power management in an optical network, comprising the steps of:
(a) providing a multi-level control of the amplifier, including:
(i) automatically determining a span loss of each fiber span in the network;
(ii) setting a target gain of the amplifier to be equal to a span loss of the fiber span immediately following the amplifier;
(iii) regulating the amplifier gain so as to be equal to said target gain;
(iv) dynamically changing said target gain of the amplifier so as to provide that a gain of a channel passing through the amplifier is within a predetermined gain range; and
(b) changing power of one or more channels passing through the amplifier so as to provide that power variation for the channels passing through the amplifier is within a predetermined power range.

2. A method as claimed in claim 1 wherein the step (a) of automatically determining the span loss comprises:
(c) selecting a channel on the optical link and turning on the channel power at the corresponding transmitter;
(d) increasing the power at said transmitter until the signal power level at the amplifier nearest to said transmitter reaches a predetermined power level;
(e) varying a target gain of said amplifier until the signal power level at the network element nearest to the amplifier reaches said predetermined power level;
(f) repeating the step (e) until the signal power level at all network elements on the optical link reaches the same said predetermined power level;
(g) determining the span loss of each fiber span as being equal to the following value:
the difference between the power at the transmitter in the step (d) and said predetermined power level, if the fiber span is located between said transmitter and the optical amplifier nearest to the transmitter; and
the target gain of the amplifier immediately preceding the fiber span, the target gain being set in the step (e), if the fiber span is any of the remaining spans of fiber.

3. A method as claimed in claim 1 wherein the step (a) of automatically determining the span loss comprises:
determining a signal power level at an input of a fiber span in the optical link;
determining a signal power level at an output of the fiber span in the optical link; and
determining the loss for the fiber span to be equal to the difference between said signal power level at the input of the fiber span and said signal power level at the output of the fiber span.

4. A method as claimed in claim 1 wherein the step (iv) of dynamically changing the target gain of the amplifier comprises changing the target gain of the amplifier so as to provide that the gain of a channel passing through the amplifier is within the predetermined gain range defined as the gain ripple of the amplifier, the gain ripple being a variation of the amplifier gain profile with channel wavelength.

5. A method as claimed in claim 1 wherein the step (b) of changing the power further comprises changing the power of one or more channels passing through the amplifier so as to provide that the power variation for the channels passing through the amplifier is opposite to the cumulative gain ripple of the amplifiers in the link so as to compensate for the cumulative gain ripple, the cumulative gain ripple of the amplifiers being a variation of the amplifiers cumulative gain profile with channel wavelength.

6. A method for automatic multi-level power management in an optical network, comprising the steps of providing a multi-level control of the amplifier, including:
(i) automatically determining span losses;
(ii) setting a target gain of the amplifier to be equal to a span loss of the fiber span immediately following the amplifier;
(iii) regulating the amplifier gain so as to be equal to said target gain; and
(iv) dynamically changing said target gain of the amplifier so as to ensure that a gain of a channel passing through the amplifier is within a predetermined gain range.

7. A method as claimed in claim 4 wherein the step (iv) of dynamically changing the target gain of the amplifier comprises changing the target gain of the amplifier so as to provide that the gain of a channel passing through the amplifier is within the predetermined gain range defined as the gain ripple of the amplifier, the gain ripple being a variation of the amplifier gain profile with channel wavelength.

8. A method for automatic multi-level power management in an optical network, comprising the steps of:
(a) providing a multi-level control of the amplifier, including:
(i) automatically determining span losses;
(ii) setting a target gain of the amplifier to be equal to a span loss of the fiber span immediately following the amplifier;
(iii) regulating the amplifier gain so as to be equal to said target gain; and
(b) changing power of one or more channels passing through the amplifier so as to provide that power variation for the channels passing through the amplifier is within a predetermined power range.

9. A method as claimed in claim 6 wherein the step (b) of changing the power further comprises changing the power of one or more channels passing through the amplifier so as to provide that the power variation for the channels passing through the amplifier is opposite to the cumulative gain ripple of the amplifiers in the link so as to compensate for the cumulative gain ripple, the cumulative gain ripple of the amplifiers being a variation of the amplifiers cumulative gain profile with channel wavelength.

10. A system for automatic multi-level power management in an optical network, comprising:
(a) means for providing a multi-level control of the amplifier, including:
(i) means for automatically determining span losses;
(ii) means for setting a target gain of the amplifier to be equal to a span loss of the fiber span immediately following the amplifier;
(iii) means for regulating the amplifier gain so as to be equal to said target gain;
(iv) means for dynamically changing said target gain of the amplifier so as to ensure that gain of a channel passing through the amplifier is within a predetermined gain range; and
(b) means for changing power of one or more channels passing through the amplifier so as to provide that power variation for the channels passing through the amplifier is within a predetermined power range.

11. A system as claimed in claim 8 wherein the means (iv) for dynamically changing the target gain of the amplifier comprises means for changing the target gain of the amplifier so as to provide that the gain of a channel passing through the amplifier is within the predetermined gain range defined as the gain ripple of the amplifier, the gain ripple being a variation of the amplifier gain profile with channel wavelength.

12. A system as claimed in claim 8 wherein the means (b) for changing the power further comprises means for changing the power of one or more channels passing through the amplifier so as to provide that the power variation for the channels passing through the amplifier is opposite to the cumulative gain ripple of the amplifiers in the link so as to compensate for the cumulative gain ripple, the cumulative gain ripple of the amplifiers being a variation of the amplifiers cumulative gain profile with channel wavelength.

13. A system for automatic multi-level power management in an optical network, comprising means for providing a multilevel control of the amplifier, including:
(i) means for automatically determining span losses;
(ii) means for setting a target gain of the amplifier to be equal to a span loss of the fiber span immediately following the amplifier;
(iii) means for regulating the amplifier gain so as to be equal to said target gain; and
(iv) means for dynamically changing said target gain of the amplifier so as to ensure that gain of a channel passing through the amplifier is within a predetermined gain range.

14. A system as claimed in claim 11 wherein the means (iv) for dynamically changing the target gain of the amplifier comprises means for changing the target gain of the amplifier so as to provide that the gain of a channel passing through the amplifier is within the predetermined gain range defined as the gain ripple of the amplifier, the gain ripple being a variation of the amplifier gain profile with channel wavelength.

15. A system for automatic multi-level power management in an optical network, comprising:
(a) means for providing a multi-level control of the amplifier, including:
(i) means for automatically determining span losses;
(ii) means for setting a target gain of the amplifier to be equal to a span loss of the fiber span immediately following the amplifier;
(iii) means for regulating the amplifier gain so as to be equal to said target gain; and
(b) means for changing power of one or more channels passing through the amplifier so as to provide that power variation for the channels passing through the amplifier is within a predetermined power range.

16. A system as claimed in claim 13 wherein the means (b) for changing the power further comprises means for changing the power of one or more channels passing through the amplifier so as to provide that the power variation for the channels passing through the amplifier is opposite to the cumulative gain ripple of the amplifiers in the link so as to compensate for the cumulative gain ripple, the cumulative gain ripple of the amplifiers being a variation of the amplifiers cumulative gain profile with channel wavelength.
